(19) United States
(12) Patent Application Publication
(10) Pub. No.: US 2020/0390280 A1
(43) Pub. Date: Dec. 17, 2020

(54) ArmaDee

(71) Applicant: Thomas Buttram, Leeton, MO (US)

(72) Inventor: Thomas Buttram, Leeton, MO (US)

(21) Appl. No.: 16/501,835

(22) Filed: Jun. 14, 2019

(51) Int. Cl. A47J 37/07

(52) U.S. Cl. CPC A47J 37/0786

(57) ABSTRACT

A shield is provided that is configured to separate foodstuffs being grilled from hot charcoal. More specifically, the shield is a single piece stainless steel designed to provide a barrier between burning charcoal coals and meat, vegetables, or fruit being cooked on a charcoal grill. The shield, thus, provides an indirect or secondary heat source for the grilling experience. The shield also reduces the unhealthy aspect of grilling meats, whereby carcinogenic compounds known as HCAs and PAHs are produced as dripping grease falls on the heat source, especially during high temperature settings.

### FIELD OF THE INVENTION

This invention relates to the consumer use of charcoal for outdoor grilling. This invention fills a gap where no product presently is available to reduce the harmful carcinogenic effects of charcoal grilling, while at the same time, providing the consumer with an appliance that will grant a finished product; that of tender, tasty, and sufficiently cooked food.

### BACKGROUND OF INVENTION

When cooking with charcoal, it is often difficult to address hot spots and related time constraints and, consequently, the chicken, steaks, or burgers end up being cooked unevenly, burned, dried out, or, not cooked thoroughly. Knowing that there must be a better way than owning a gas or pellet grill, experiments were conducted with a an aluminum shield that would provide an indirect heat source. The solution to this problem was a shield with a predefined ratio of open holes per area of the shield, arc of the shield, the amount of dimple of holes, and size.

Coinciding with the need to cook meats slower for flavor and moisture retention, was the underlying need to present a safer food product the invention described herein achieves the desired cooking result and at the same time, providing much safer food to consume.

### BRIEF SUMMARY OF THE INVENTION

The shield is a single piece stainless Steel device that is designed to provide a barrier between burning charcoal coals and meat, vegetables, or fruit being cooked on a charcoal grill. The essence is that of providing an indirect or secondary heat source for the grilling experience.

The purpose of shield is three-fold:

1. To prevent or reduce burning of food items such as steak and chicken, by reducing and evenly distributing heat to all areas of grill surface while at the same time maintaining moisture content and tender-well cooked features.

2. To prevent dangerous flare-ups when opening grill lid or while turning and seasoning meat.

3. To greatly reduce the unhealthy aspect of grilling meats whereby carcinogenic compounds known as HCAs and PAHs are produced as dripping grease falls on heat source especially during high temperature settings. The shield reduces cooking temperatures by approximately 50%.

The shield greatly reduces the amount of fats that fall on burning coals by more than 90%. This is accomplished by the design of one ⅜″ hole per 7.09 square inches of indirect heat surface and the utilization of dimpled holes in an upward fashion to prevent draining grease from entering holes.

The shield greatly reduces the amount of fats that fall on burning coals by more than 90%. This is accomplished by the design of one ⅜″ hole per 7.09 square inches of indirect heat surface and the utilization of dimpled holes in an upward fashion to prevent draining grease from entering holes.

The shield is designed with an ⅛″ beaded edge to protect toes and feet of bare or sandaled feet, should it be dropped.

Another feature of shield is the attached D-ring that enables it to be safely handled with gloves or fork.

The shield presently is produced in two styles, rectangular and circular, in order to accommodate many grill designs and sizes.

### BRIEF DESCRIPTION OF THE DRAWINGS

FIG. 1 comprises CAD drawings for circular shield design;

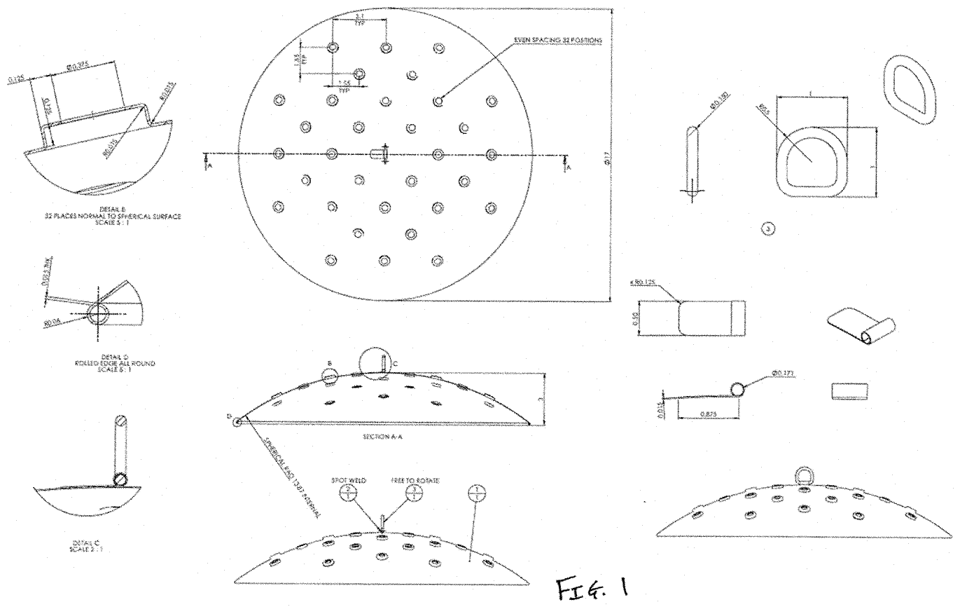

FIG. 2 is an image of a shield of a circular design;

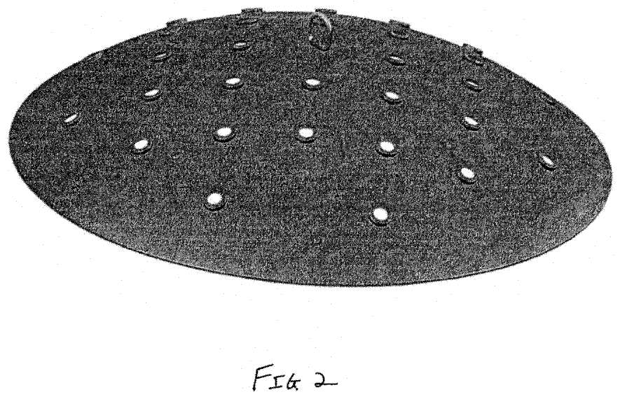

FIG. 3 comprises CAD drawings for rectangular shield design; and

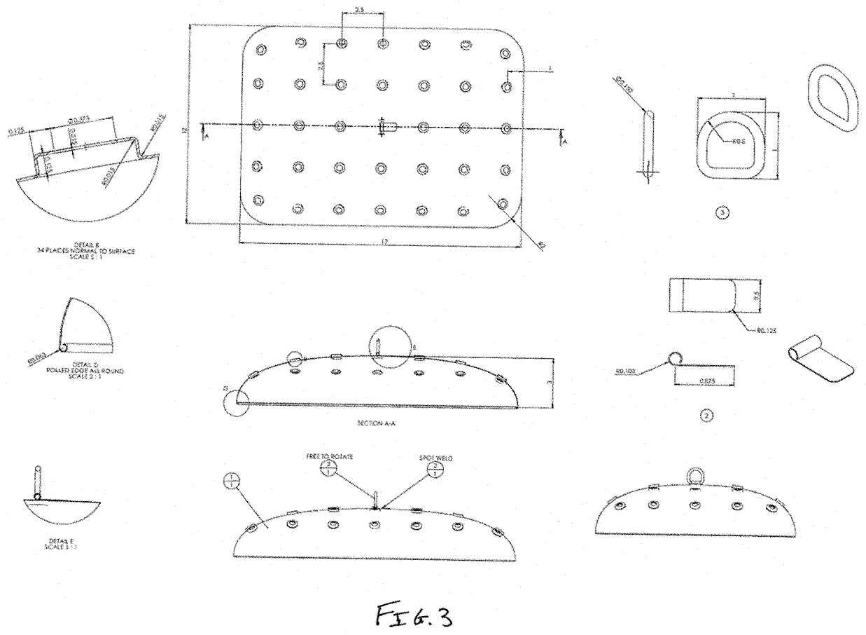

FIG. 4 is an image of a shield rectangular design

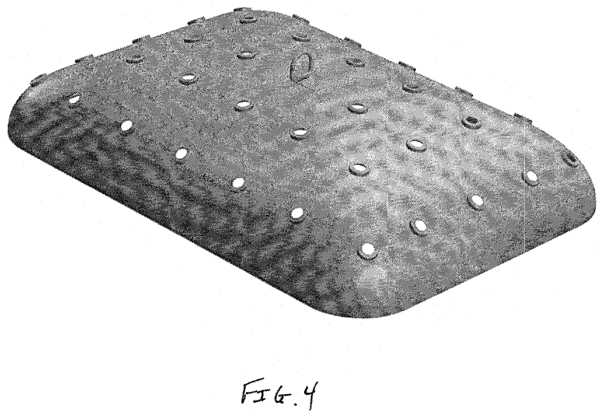

### DETAILED DESCRIPTION

Whether it is the circular or the rectangular device described herein; the manufacture and use is the same, regardless of the design of grill to be used on. The circular version is 17″ in diameter and 3″ deep in the center, while the rectangular version is 17″ by 12″ with the same depth of 3″.

The shield serves as an indirect heat source for charcoal grill cooking. It is made of approximately 28 guage. stainless steel sheet and formed using a stamping process with corresponding dies to accomplish desired shape, holes and dimples. Following the stamping process, the appliance receives the edge beading by using a beading machine. Next, the appliance is buffed, then the D-ring application is spot welded to the center of appliance followed by application of Trademark.

Consumer use constitutes of heating charcoal coals to white hot, distributing them in grill by simply knocking them around until somewhat even. The shield is placed directly over them and optionally placed wood chips, then the grill is placed in position, the food is then placed on grill. In most cases, meats are then cooked undisturbed for 20-30 minutes, then grill is opened and meat is turned over and cooked for another 10-20 minutes.

While there are composite and metal pans designed to cook vegetables, fish, and seafood on top of the grill, they are mainly to keep those items from falling through the grates of the grill, there is nothing like the shield which functions directly between the coals and the grill, evenly distributing heat while reducing it by as much as 50%, yet allowing smoke to season the cooking food.

The ⅜ inch holes are distributed evenly at an approximate rate of 1 per 7 square inches. Each hole is sheltered by an upward shoulder or dimple that prevents dripping grease from leaking back into hole by draining. It is possible for as much as 10% of dripping grease to fall directly into hole, but the Heterocyclic Amines (HCAs) and Polycyclic Aromatic Hydrocarbons (PAHs) that may be created when grease comes in contact with hots coals, will most likely attach to the inside of appliance, rather than the meat you feed to your family. This wonderful feature will attribute a healthier lifestyle to the consumer's family and friends. (see National Cancer Institute—carcinogenic effects of grilling).

1-3. (canceled)

4. A metal shield configured to be placed between hot charcoal coals and food being cooked that acts as a secondary heat source, comprising:
a member having a curved profile bounded by an outer edge; and
a plurality of cylindrical protrusions extending from an outer surface of the member, wherein each protrusion ends at a substantially planar surface with an aperture extending therethrough.

5. The shield of claim 4, wherein the outer edge is circular.

6. The shield of claim 4, wherein the outer edge is rectangular.

7. The shield of claim 4, wherein outer edge includes a bead comprised of a portion of the member that is curled inwardly and associated with an inner surface of the member.

8. The shield of claim 4, wherein the plurality of cylindrical protrusions are about 0.125 inches high and about 0.625 inches wide, and wherein the apertures have a diameter of about 0.375 inches.

9. The shield of claim 4, wherein cooking temperatures are reduced by about 50%.

10. The shield of claim 4, further comprising a d-ring interconnected to the outer surface of the member.

11. The shield of claim 4, wherein the plurality of protrusions are distributed evenly approximately one protrusion per about seven square inches.
